(19) United States
(12) Patent Application Publication
(10) Pub. No.: US 2014/0060958 A1
(43) Pub. Date: Mar. 6, 2014

(54) HETERODYNED ECCENTRIC VIBRATOR

(71) Applicants: Peter M. EICK, Houston, TX (US); Joel D. BREWER, Houston, TX (US)

(72) Inventors: Peter M. EICK, Houston, TX (US); Joel D. BREWER, Houston, TX (US)

(73) Assignee: CONOCOPHILLIPS COMPANY, Houston, TX (US)

(21) Appl. No.: 13/717,813

(22) Filed: Dec. 18, 2012

Related U.S. Application Data
(60) Provisional application No. 61/578,437, filed on Dec. 21, 2011.

(51) Int. Cl. B06B 1/16

(52) U.S. Cl. CPC B06B 1/162
USPC 181/121

(57) ABSTRACT

The invention relates to delivering seismic energy with rotating eccentrics where the eccentrics are driven at relatively high, but different rotational rates create a heterodyned frequency of seismic energy into the earth. The rotating eccentrics may be rotated in opposite directions to deliver pressure waves or in the same direction to create a shear component to the seismic impulses.

### CROSS-REFERENCE TO RELATED APPLICATIONS

This application is a non-provisional application which claims benefit under 35 USC §119(e) to U.S. Provisional Application Ser. No. 61/578,437 filed Dec. 21, 2011, entitled “Heterodyned Eccentric Vibrator,” which is incorporated herein in its entirety.

### STATEMENT REGARDING FEDERALLY SPONSORED RESEARCH

None.

### FIELD OF THE INVENTION

This invention relates to seismic prospecting and especially to technology for delivering seismic energy into the earth in search of hydrocarbon resources.

### BACKGROUND OF THE INVENTION

In the process of acquiring seismic data, seismic energy is delivered into the earth. Over the years, the preferred attributes of the seismic energy delivered into the earth have been honed to include a broad spectrum of wavelengths and sufficient power across the spectrum to be recorded at the surface. In general, a suitable source must be able to deliver seismic energy waves in a spectrum of wavelengths from about 4 Hz up to 60-80 Hz. The source must have sufficient power across the spectrum so that the seismic waves have measurable amplitude at the surface after transiting deep into the earth, reflecting from or refracting through layers in the earth and transiting back to the surface. A last major characteristic of a desirable seismic source is that the energy from the source is distinguishable in the data record from seismic energy from other sources whether from background sources or other seismic prospecting.

Explosive charges have long been used as seismic sources although the intense release of energy is typically not permitted except in remote locations. Explosive sources, however, provide a wide array of wavelengths with considerable power across the wavelengths.

Hydraulic reciprocating seismic vibrators or vibes have been in use for many years using a baseplate connected to hydraulic rams that cause a reaction mass to reciprocate up and down to shake the ground through the baseplate. The hydraulic rams are operated to move the reaction mass through a sweep of the desired frequencies. However, the hydraulic systems are limited in their ability to provide sufficient power at high frequencies due to limitations of hydraulic flow in and out of the hydraulic cylinders. At very high hydraulic velocities, the hydraulic fluid is subject to cavitation when reversing directions that limits the amplitude of the movement of the reaction mass and thus the energy input in to the earth. At low frequencies it is difficult for the hydraulic vibe to have enough travel to generate a low frequency wave into the ground. For example, consider how one would generate a one Hz wave with a hydraulic vibe. A very long throw of the reaction mass is needed to generate that wavelet because the mass has to be moving down and up the full one second.

### BRIEF SUMMARY OF THE DISCLOSURE

The invention more particularly includes process for delivering seismic energy into the ground wherein a seismic baseplate is lowered into contact with the ground and a plurality of eccentric impulse devices that are attached to the seismic baseplate are rotated to impart impulses into the earth. The rotation of the eccentric impulse devices are controlled to heterodyne the impulse that each eccentric impulse device and effectively impart a more powerful impulse into the earth and the returning wavefield of seismic energy returning from the subsurface is sensed and recorded for subsequent analysis.

### BRIEF DESCRIPTION OF THE DRAWINGS

A more complete understanding of the present invention and benefits thereof may be acquired by referring to the follow description taken in conjunction with the accompanying drawings in which:

FIG. 1 is an elevation view of an inventive eccentric impulse seismic sweep vibrator with the baseplate lowered to the ground;

FIG. 2 is a perspective view of the baseplate with a pair of eccentric impulse devices mounted on top of the baseplate;

FIG. 3 is a perspective view of the baseplate with four eccentric impulse devices mounted thereon;

FIG. 4 is a perspective view of the baseplate with six eccentric impulse devices mounted thereon where two are mounted transversely to the other four to create; and

FIG. 5 is a perspective cut away view of and alternative embodiment of the roller body showing the eccentric mass in its neutral position and deployed into a retracted or extended position to increase the effective eccentricity of the roller body while rotating.

### DETAILED DESCRIPTION

Turning now to the detailed description of the preferred arrangement or arrangements of the present invention, it should be understood that the inventive features and concepts may be manifested in other arrangements and that the scope of the invention is not limited to the embodiments described or illustrated. The scope of the invention is intended only to be limited by the scope of the claims that follow.

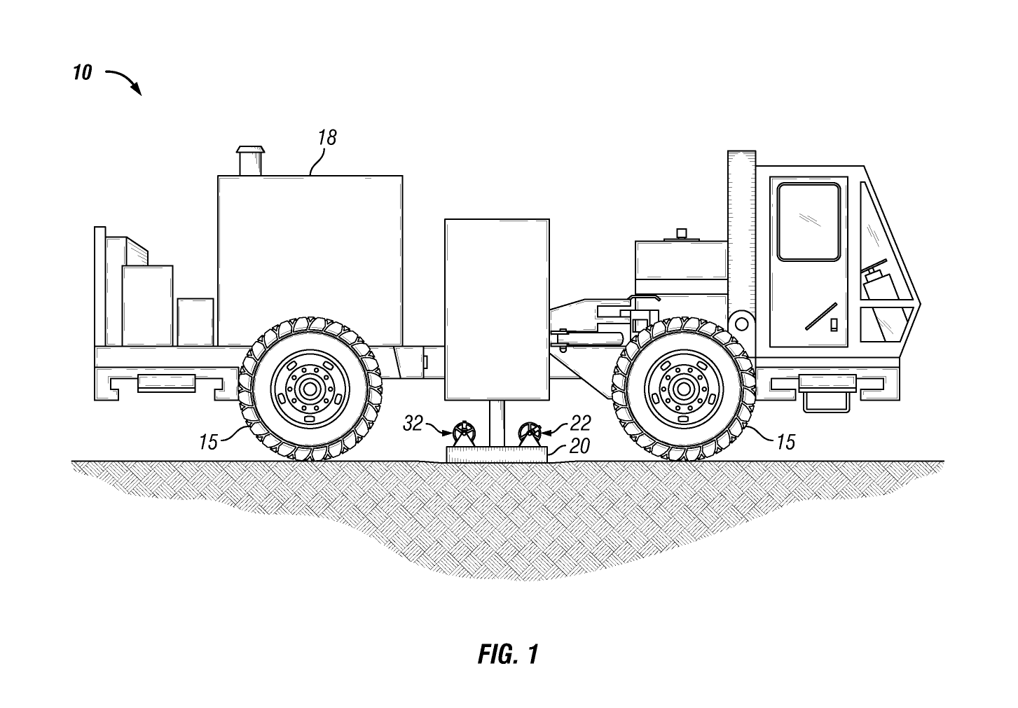

As shown in FIG. 1, a seismic sweep vibrator is generally indicated by the numeral 10. The vibrator 10 includes large tires 15 to move from location to location, a power unit 18, such as a diesel motor, and baseplate 20 which is shown lowered to the ground G when delivering seismic energy into the ground but may be raised for the vibrator 10 to move to another location. With the baseplate 20 lowered to the ground G, a significant portion of the weight of the vibrator 10 is lifted off the wheels 15 so that a much of the weight of the vibrator 10 is applied to the ground and the baseplate 20 does not “jump” around while delivering seismic energy to the ground G. Also, by not taking all of the weight off the wheels 15, the vibrator is still stable and has no tendency to tip over or rock while in operation. The baseplate 20 includes first and second eccentric impulse devices 22 and 32 mounted to the top portion thereof.

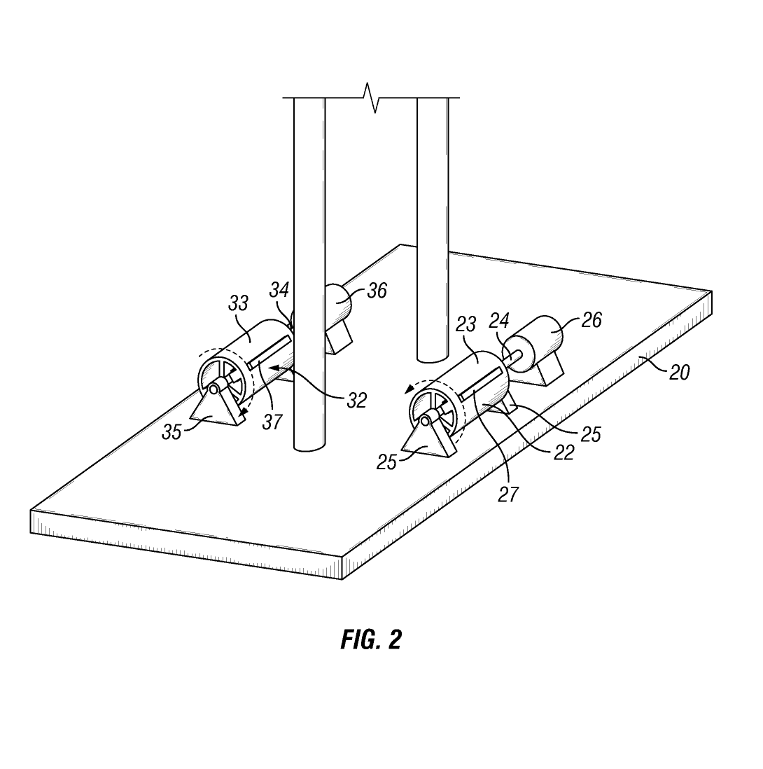

As best seen in FIG. 2, the first eccentric impulse device 22 includes a roller body 23 that is mounted for rotation about shaft 24 that is supported above the baseplate 20 by brackets 25. Brackets 25 each include robust, but conventional roller type or thrust type bearings to permit roller body 23 to rotate freely about a generally horizontal axis. Vibrational input drive 26, also mounted to baseplate 20, is attached to the shaft 24 and provides rotational force to turn the roller body 23 at rotational speeds that may be fairly precisely controlled. Vibrational input drive 26 may be hydraulic or electric or powered by other controllable power technology. Adjacent to the first eccentric impulse device 22 is a second eccentric impulse device 32 having similar construction. In particular, second eccentric impulse device 32 includes a roller body 33 that is mounted for rotation about shaft 34 and supported above the baseplate 20 by brackets 35. Bearings to permit roller body 33 to rotate freely about a generally horizontal axis that, in this embodiment, is generally parallel to shaft 24. Also, a vibrational input drive 36 is mounted to baseplate 20 and attached to the shaft 34 and provide rotational force to turn the roller body 33 at rotational speeds that are also fairly precisely controlled. The respective vibrational input drives 26 and 36 may rotate in opposite directions or the same direction depending on the seismic waves intended to be put into the ground.

Each of the roller bodies 23 and 33 include an eccentric mass identified by the number 27 on roller body 23 and as eccentric mass 37 on roller body 33. Eccentric masses 27 and 37 are preferably a highly dense material such as depleted uranium or tungsten to provide roller bodies 23 and 33 with a center of mass that is not coaxial with the respective roller body 23 or 33. As the roller body 23 and 33 rotates around its respective axis or shaft, 24 and 34, respectively, each provides a vibration that is dependent on the mass of the roller bodies 23 and 33, the distance the center of the mass for each roller body 23 and 33 from the respective shaft 24 and 34 and the speed at which the roller body 23 and 33 is rotated about its respective shaft 24 and 34.

Each eccentric impulse device 22 or 32, while rotating will provide a base vibrational frequency. However, while both are rotating, and especially while rotating at different rotational speeds or rates, the two eccentric impulse devices 22 and 32 will also provide compounding frequencies based on heterodyning where the frequencies may be added or subtracted from one another. Thus, four frequencies will be emitted, and all frequencies may be recognized by seismic recording systems. The heterodyned subtraction frequencies that are created by fairly high rotational speeds are interesting from a seismic prospecting standpoint in that high speeds provide high energy levels of seismic energy but frequencies that are relevant to seismic surveying. Such high energy frequencies may be useful for seismic hydrocarbon prospecting. Operating a single eccentric device at the low frequencies of interest using the roller body of the same size as roller body 23 and using a vibrational input drive the same size as vibrational input drive 26 would not provide sufficient energy to be useful in the data record of a seismic recording system. A much, much larger eccentric impulse device that would be impractical to take into the field considering the size of a vehicle to carry it into the field and from source location to source location. Heterodyning a pair of simple eccentric impulse devices 22 and 32 provides a practical and low cost method for delivering seismic energy to the ground for seismic hydrocarbon prospecting.

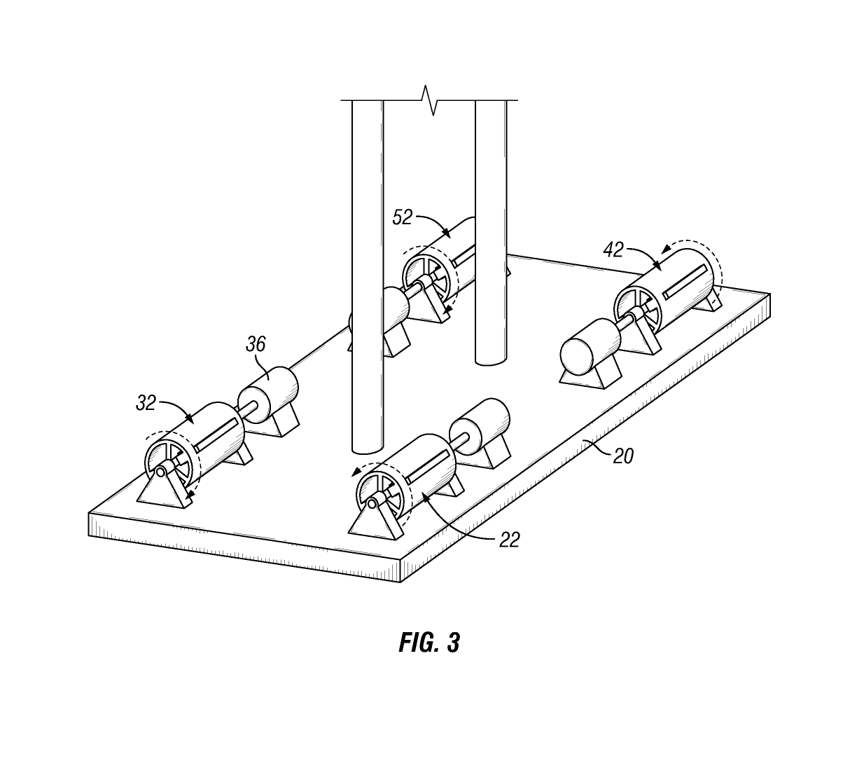

As shown in FIG. 3, it may be that an additional pair of eccentric impulse devices 42 and 52 may be desired. All four eccentric impulse devices are envisioned to work together where two impulse devices would be of similar size, shape and power and would rotate at the same relative speed throughout the seismic sweep while the other two operated also at the same relative speed between the second two, but at a different speed than the first two to create at heterodyne frequency sweep from about 4 Hz up to about 100 Hz over a period of about 10 seconds to a minute.

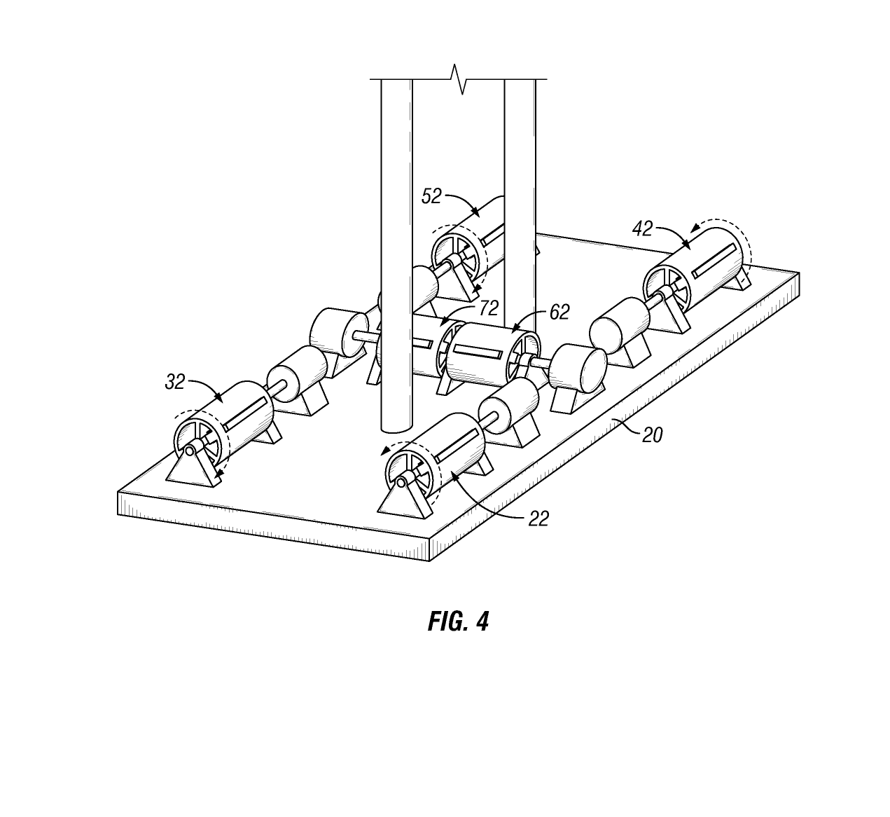

As shown in FIG. 4, a third additional pair of eccentric impulse devices 62 and 72 may be added where the third pair is also horizontal but transverse to the four eccentric impulse devices 22, 32, 42 and 52. Other arrangements may be considered where pairs of eccentric impulse devices are at various angles relative other pairs and that creative signals may be created where the heterodyned output signals are cross line shear waves or side to side motions or inline shear waves or a front to back motion wave. The heterodyned output signal may also be a rocking or bending motion all which may be created using combinations of heterodyned pairs of eccentric impulse devices.

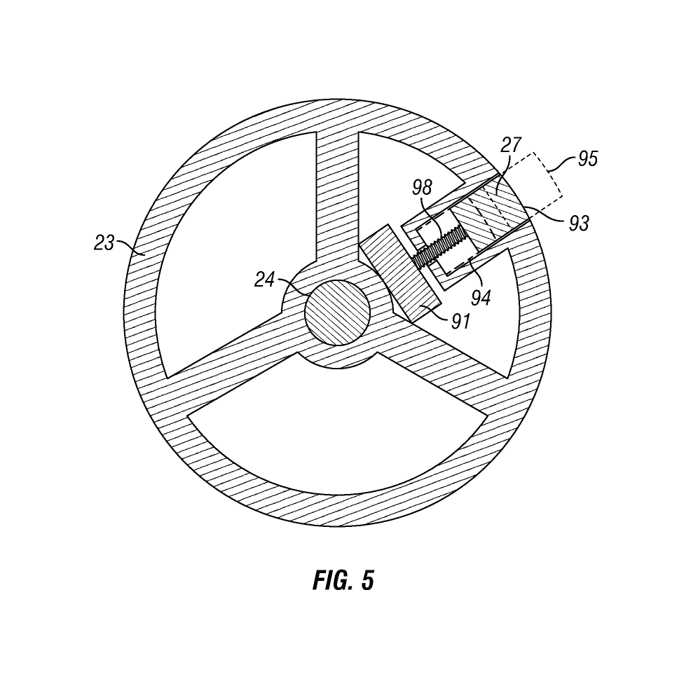

Turning to FIG. 5, in one alternative embodiment, the eccentric mass 27 may be arranged to move relative to the roller body 23 while in motion to alter the eccentricity of the roller body 23. For example, an electric step motor 91 is mounted within the roller body to maintain the eccentric mass at a first position 93 which creates very low eccentricity of the roller body 23. As the vibrational input drive 26 rotates the roller body 22 up to a desired first rotational rate, very little seismic energy is emitted by the eccentric impulse device. Power may be provided to the step motor to change the position of the eccentric mass 27 to either pull in closer to the axis at position 94 or move further away from the axis to position 95 to create higher eccentricity. This adjustment by be done by either internal stepper motors or via a clutch type mechanism using internal hydraulics to control the motion of the eccentric weight. At the first rotational speed, seismic energy would then be emitted into the ground. The vibrational input drive 26 would progressively alter the rotational speed of the roller body 23 with respect to the rotational speed of the other of the heterodyned pair of eccentric impulse devices 22. After a pre-set course of rotational speed progressions, the stepper motor or a clutch type mechanism is then provided the signal and power to recall the eccentric mass 27 to its neutral position 93 in readiness to raise the baseplate 20 in preparation to move locations of vibe 10 or while the roller mass is slowed to a stop. It should be understood that multiple sweeps of seismic energy may be emitted while the vibe 10 is at one source point and the roller mass 23 may be kept rotating at a high speed in anticipation of a second or subsequent sweep of seismic energy broadcasting. Eventually, the eccentric mass 27 in the roller bodies 22 and 32 and others as appropriate will be recalled to its neutral position for lifting of the baseplate 20 for the vibe 10 to move to another source location or for stopping roller bodies 22 and 32 and others as appropriate so the baseplate 20 can be lifted from the ground for the vibe 10 to move to another source location for further seismic prospecting.

The preferred frequency range of the sweep is from about 1 Hz up to about 200 Hz. High frequencies may vary from survey to survey but are generally at least 80 Hz and commonly up to 120 Hz. Low frequencies may vary from survey to survey but in general they are at least down to 4 Hz and commonly down to 2 Hz.

The vibrator 10 includes electronic circuitry to control the vibration input drives 26 and 36 so that eccentric impulse devices 22 and 32 operate in conjunction with one another to provide combined vibrational power through the baseplate 10 in a heterodyne fashion.

With the arrangement shown in FIG. 1 through 3, the seismic energy will primarily comprise pressure waves or p-waves. However, in FIG. 4, providing at least one pair of transverse eccentric impulse devices 62 and 72 provide the capability to provide a shear wave component or s-waves into the earth. With minimal tuning, counter rotating eccentric impulse devices cancel shear waves and magnify the p-waves. However, there are surveys which shear waves provide helpful data.

In closing, it should be noted that the discussion of any reference is not an admission that it is prior art to the present invention, especially any reference that may have a publication date after the priority date of this application. At the same time, each and every claim below is hereby incorporated into this detailed description or specification as a additional embodiments of the present invention.

Although the systems and processes described herein have been described in detail, it should be understood that various changes, substitutions, and alterations can be made without departing from the spirit and scope of the invention as defined by the following claims. Those skilled in the art may be able to study the preferred embodiments and identify other ways to practice the invention that are not exactly as described herein. It is the intent of the inventors that variations and equivalents of the invention are within the scope of the claims while the description, abstract and drawings are not to be used to limit the scope of the invention. The invention is specifically intended to be as broad as the claims below and their equivalents.

1. A process for delivering seismic energy into the ground comprising:
a) lowering a seismic baseplate into contact with the ground;
b) rotating a plurality of eccentric impulse devices attached to the seismic baseplate to impart impulses into the earth;
b) controlling the rotation of the eccentric impulse devices to heterodyne the impulse that each eccentric impulse device and effectively impart a more powerful impulse into the earth; and
e) sensing a returning wavefield of seismic energy returning from the subsurface and recording the sensed vibrations for subsequent analysis.

2. The process for delivering seismic energy into the ground according to claim 1, wherein each eccentric impulse device includes a shaft with a weighted rotational element wherein the rotational element includes an eccentric weight that is adjustable while rotating to alter the eccentric impulse delivered to the earth.

3. The process for delivering seismic energy into the ground according to claim 2, wherein each eccentric impulse device includes a vibrational input drive to provide rotational power to the eccentric impulse device.

4. The process for delivering seismic energy into the ground according to claim 3, wherein the heterodyned output signal is a cross line shear wave or a side to side motion.

5. The process for delivering seismic energy into the ground according to claim 3, wherein the heterodyned output signal is a inline shear wave or a front to back motion.

6. The process for delivering seismic energy into the ground according to claim 3, wherein the heterodyned output signal is a rocking or bending motion.

7. The process for delivering seismic energy into the ground according to claim 1, wherein the heterodyned output signal is controlled to create a frequency sweep through a range of frequencies.
